(19) United States
(12) Patent Application Publication
(10) Pub. No.: US 2022/0414764 A1
(43) Pub. Date: Dec. 29, 2022

(54) FINANCING ANALYSIS METHOD AND SYSTEM BASED ON LIFE POLICY INFORMATION

(71) Applicants: Hang Wah YIM, HongKong (CN); Mei Hing CHEUNG, HongKong (CN)

(72) Inventors: Hang Wah YIM, HongKong (CN); Mei Hing CHEUNG, HongKong (CN)

(21) Appl. No.: 17/358,015

(22) Filed: Jun. 25, 2021

(51) Int. Cl. G06Q 40/02; G06Q 40/06; G06Q 40/08; G06F 16/2455

(52) U.S. Cl. CPC G06Q 40/025; G06Q 40/06; G06Q 40/08; G06F 16/2455; G06Q 50/16

(57) ABSTRACT

A financing analysis method based on life policy information includes: step A: establishing an online investment database with a plurality of investment proposals, and updating the online investment database in real time or regularly; step B: receiving the life policy information input externally; and step C: analyzing a loanable amount according to the input life policy information and each investment proposal in the online investment database, and calculating a plurality of loan proposals and a maximum loanable amount of a corresponding life policy. A financing analysis system based on life policy information is further provided. The new method and system can help a policyholder to understand the maximum loanable amount and personal loan proposals on the online market, thereby optimizing loan selection and promoting policy liquidity.

### TECHNICAL FIELD

The present invention relates to the technical field of information and data processing, and more particularly, to a financing analysis method and system based on life policy information.

### BACKGROUND

In the prior art, universal life (UL) insurance is a life insurance product that provides a protection function and has a certain asset value in at least one investment account.

Like traditional life insurance, UL insurance provides life protection to the policyholder. In addition, it can also allow the customer to directly participate in the investment activities of funds in the investment account established by the insurance company for the policyholder, linking the value of the life policy with the performance of the capital in the policyholder's investment account independently operated by the insurance company. Most of the premiums of UL insurance are used to purchase investment account units set up by the insurance company. Investment experts are responsible for the transfer and investment decisions of funds in the account to put the funds of the policyholder into various investment tools. They also calculate the asset value in the investment account and ensure that the policyholder can participate in investment operations with the help of expert's financial management while obtaining the principal of the account balance and a certain amount of interest.

UL insurance offers a low guaranteed interest rate, which is roughly the same as participating insurance. The payment of the premium and the change of the insured amount under the insurance contract are flexible, which can fully meet the protection needs of the customer in different periods. UL insurance provides a minimum guaranteed interest rate and a possibility that a high interest rate brings a high return, which is attractive to customers.

Second mortgage refers to an additional mortgage loan applied for in addition to the first mortgage of a life policy.

In the prior art, premium financing generally only accepts a large UL insurance policy, where the customer needs to pay the premiums in one lump sum, but most of the premiums can be financed by the bank. Every life policy in force (IF) has a cash value, and the policyholder can apply for a mortgage loan from the bank based on the cash value. For example, the policyholder may borrow a loan of 80% or more of the cash value. In the context of low interest rates, the policyholder can earn an interest spread through premium financing to reduce the cost of insurance.

However, due to the high fixed costs, premium financing has always been limited to high-end customers. If the guaranteed cash value (GCV) of the life policy is excessively low, the bank may not be interested in lending. Moreover, because of the uncertainty of the projected cash value, dividend and accrued interest rate, it is generally not permitted to modify the financed life policy or increase the loan amount during the term. The payment terms are completely determined by the bank, and all loan terms are fixed at the beginning. For example, when a bank accepts a life policy loan, it usually specifies static loan terms (such as single premium life policy, loan amount, specified term and specified insurance product), and no second mortgage or policy modification is allowed. This restricts policy liquidity and lacks transparency for the policyholder.

### SUMMARY

In view of this, the present invention provides a financing analysis method and system based on life policy information. The present invention can help a policyholder to understand the maximum loanable amount and personal loan proposals on the online market, thereby optimizing loan selection and promoting policy liquidity.

The technical solution of the present invention is implemented as follows.

A financing analysis method based on life policy information includes the following steps:

step A: establishing an online investment database with a plurality of investment proposals, and updating the online investment database in real time or regularly;

step B: receiving the life policy information input externally; and

step C: analyzing a loanable amount according to the input life policy information and each investment proposal in the online investment database, and calculating a plurality of loan proposals and a maximum loanable amount of a corresponding life policy.

Preferably, the life policy information includes:

a projected guaranteed cash value (GCV) of the life policy, information regarding whether the life policy is transferrable to a transferee, and information regarding past loans and selected loans of the life policy.

Preferably, the life policy information further includes:

a best estimate projected cash value, a cost of insurance, a premium of a newly-built life policy, a cash value of a life policy in force in real time, a future premium, and a regular guaranteed cash flow of other life policy.

Preferably, the method further includes:

step D: performing financing evaluation analysis based on the calculated loan proposals, and calculating evaluation statistics of each loan proposal; and

step E: outputting a loan recommendation and a selection list according to the evaluation statistics of each loan proposal.

Preferably, the method further includes:

step F: recording a loan proposal selected by a user from the list of the loan proposals, updating the online investment database with an investment proposal corresponding to a newly-added selected loan of the user, and returning to step C.

Preferably, step C includes:

step C1: determining whether the GCV of the corresponding life policy supports all past loans and selected loans according to the input life policy information; if yes, proceeding to step C2; otherwise, ending a process;

step C2: generating a corresponding loan proposal according to the input life policy information and each investment proposal stored in the online investment database, and calculating a maximum loanable amount of each loan proposal; and

step C3: determining whether financing is allowable according to the maximum loanable amount of each loan proposal and a preset financing threshold; if yes, proceeding to subsequent step D; otherwise, ending the process.

Preferably, the step of determining whether the GCV of the corresponding life policy supports all the past loans and the selected loans according to the input life policy information includes:

calculating a remaining loan amount (RLA) of the corresponding life policy according to the input life policy information; and

determining that the GCV of the life policy corresponding to the life policy information supports all the past loans and the selected loans when the RLA of the life policy is greater than a preset loan threshold; otherwise, determining that the GCV of the life policy corresponding to the life policy information does not support all the past loans and the selected loans.

Preferably, the RLA of the life policy is calculated as follows:

RLA=min_{t=0 . . . max(t}_{₁}_{, . . . , t}_{ₘᵢₙ}₎GVC(t)×α−Σ_{y=1 . . . m+o}la_{y};

wherein, RLA is the remaining loan amount of the life policy; GCV(t) is the projected guaranteed cash value of the life policy; t₁, . . . , tₘ₊ₒ are loan terms of 1^{st} to (m+o)^{th} past loans or selected loans; α is a risk factor; la_{y} is a y^{th} loan amount of all the past loans and the selected loans; m and o are the number of the past loans and the number of the selected loans, respectively.

Preferably, a maximum loanable amount of an x^{th} loan proposal Lₓ is calculated as follows:

aₓ=min{aiaₓ,[min_{t=0 . . . max(t}_{₁}_{, . . . , t}_{ₘᵢₙ}₎GVC(t)×α]−Σ_{y=1 . . . m+o}la_{y}};

wherein, aₓ is the maximum loanable amount of the generated x^{th} loan proposal Lₓ;

aiaₓ is an available investment amount of the x^{th} loan proposal.

Preferably, the evaluation statistics includes:

a latest expected repayment period, a policy cash flow, a break-even interest rate, a cash flow after projected premium financing, an expected interest arbitrage benefit, an increase in an internal rate of return, and a worst-case loss.

Preferably, step E includes:

comparing and sorting the loan proposals according to a preset sorting parameter and the evaluation statistics of each loan proposal, and outputting a sorted list of the loan proposals.

Preferably, step E includes:

receiving an externally input normative instruction; and

comparing and sorting the loan proposals according to the externally input normative instruction and the evaluation statistics of each loan proposal, and outputting a sorted list of the loan proposals.

Preferably, the normative instruction includes:

maximizing parameters such as a target parameter, a loan amount and/or a loan term.

A financing analysis system based on life policy information includes a storage unit and a loanable amount analysis unit.

The storage unit is configured to store an online investment database with a plurality of investment proposals, and update the online investment database in real time or regularly.

The loanable amount analysis unit is configured to receive the life policy information input externally, analyze a loanable amount according to the input life policy information and each investment proposal in the online investment database, and calculate a plurality of loan proposals and a maximum loanable amount of a corresponding life policy.

Preferably, the financing analysis system based on life policy information further includes a financing evaluation analysis unit.

The financing evaluation analysis unit is configured to perform financing evaluation analysis based on the calculated loan proposals, calculate evaluation statistics of each loan proposal, and output a loan recommendation and a selection list according to the evaluation statistics of each loan proposal.

Preferably, the storage unit is further configured to record a loan proposal selected by a user from a list of the loan proposals, and update the online investment database with an investment proposal corresponding to a newly-added selected loan of the user.

In the financing analysis method and system based on life policy information of the present invention, a plurality of loan proposals for a life policy and a maximum loanable amount of the life policy can be dynamically calculated according to the current online investment database and the externally input life policy information, and then a loan recommendation and a selection list are output, so as to facilitate the policyholder to understand the maximum loanable amount of the life policy, the interest spread of financing and the personal loan proposals on the online market. In this way, even a small life policy can use its cash value as a collateral to loan, which greatly reduces the threshold of premium financing and improves the flexibility of premium financing. Therefore, the present invention can optimize loan selection and promotes policy liquidity. The present invention supports second mortgage and modification of the life policy (for example, withdrawal), and also supports the use of accrued interest of the life policy as a collateral to increase the loan amount. In this way, the present invention realizes the transparency of the loan-to-value ratio of the life policy, and solves the problem of high costs of small premium financing, a plurality of loans for one life policy or modification of a mortgage life policy.

### BRIEF DESCRIPTION OF THE DRAWINGS

FIG. 1 is a flowchart of a financing analysis method based on life policy information according to an embodiment of the present invention.

FIG. 2 is a structural diagram of a financing analysis system based on life policy information according to an embodiment of the present invention.

### DETAILED DESCRIPTION OF THE EMBODIMENTS

In order to make the objectives, technical solutions and advantages of the present invention clearer, the present invention is described in detail below with reference to the drawings and embodiments.

A guaranteed cash value (GCV) of a life policy is a low-risk collateral. Since an investor only participates in the credit risk management of an insurance company, if a policyholder cannot repay a loan, an investment lender can repay the loan with the GCV. The present invention provides a financing analysis method and system based on life policy information. The present invention enables a policyholder to understand the maximum loanable amount and personal loan proposals on the online market, thereby optimizing loan selection and promoting policy liquidity.

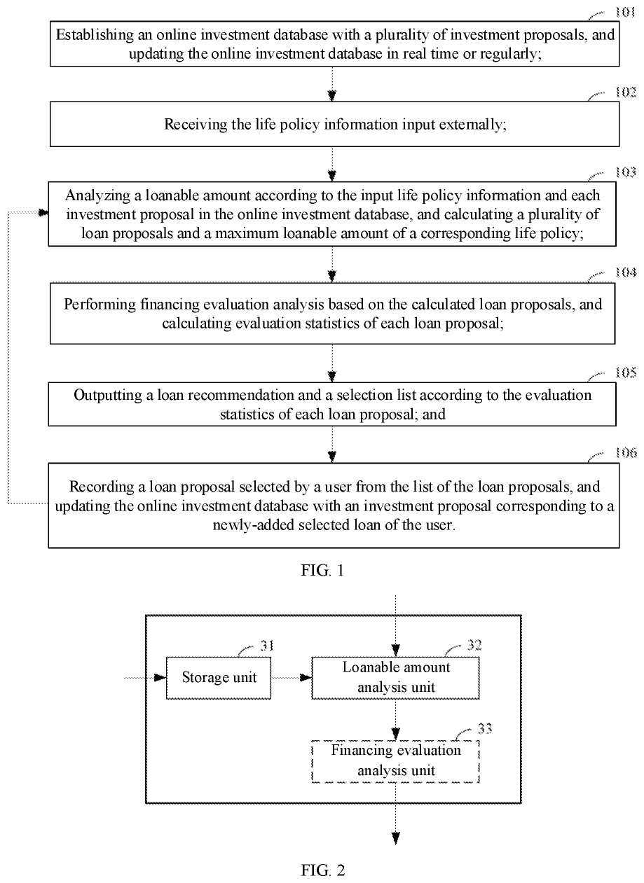

FIG. 1 is a flowchart of a financing analysis method based on life policy information according to an embodiment of the present invention. As shown in FIG. 1, the financing analysis method based on life policy information according to the embodiment of the present invention includes the following steps.

Step 101: an online investment database with a plurality of investment proposals is established, and the online investment database is updated in real time or regularly.

In the technical solution of the present invention, the online investment database needs to be established first. The online investment database stores the plurality of investment proposals, and continuously updates the investment proposals in real time or regularly, so as to continuously supplement or update the investment proposals stored in the online investment database.

For example, preferably, in a specific embodiment of the present invention, an individual or an institutional investor may input the investment proposals online, and the investment proposals is stored in the online investment database, so that the online investment database is updated in real time or regularly.

In addition, for the convenience of description, the technical solution of the present invention is described in detail below by taking an interest-only loan, a single premium or a paid-up life policy as an example. The technical solution of the present invention also may be applied to other conditions or situations, and is not limited to the above conditions or situations.

For example, preferably, in a specific embodiment of the present invention, the investment proposal may include an interest (iₓ), a term (tₓ) and an available investment amount (aiaₓ) and other information.

Step 102: externally input life policy information is received.

In this step, a system may receive the life policy information input by a user through an input/output (I/O) device or an application programming interface (API). For example, the life policy information may be directly input by the user through the I/O device, or may be input by an insurance company or an intermediary company through the API, which is not limited by the present invention.

For example, preferably, in a specific embodiment of the present invention, the life policy information may include:

1. a guaranteed cash value (GCV(t)) of a life policy, where t is a time point in the future; the GCV refers to a minimum amount guaranteed by a life insurance company to be returned when an insured person requests to terminate or surrender the life policy;

2. information regarding whether the life policy is transferrable to a transferee; and

3. information regarding past loans and selected loans of the life policy.

Preferably, in a specific embodiment of the present invention, the life policy information may further include:

1. a best estimate projected cash value PCV(t);

2. a cost of insurance (t);

3. a premium of a newly-built life policy, i.e. premium (0), or a cash value of a life policy in force (IF) in real time, i.e. GCV(0); and

4. a future premium and a regular guaranteed cash flow (CF) of other life policy.

In the technical solution of the present invention, when the life policy has a past loan, the system will query a corresponding record or request the input of the past loan information of the life policy.

Preferably, in a specific embodiment of the present invention, the past loan information may include an interest rate of the past loan, a remaining term, a loan amount and other information.

The past loan information may further include (non-mandatory information): loan number, down payment, monthly payment, term, date of arrears and other information.

Preferably, in a specific embodiment of the present invention, the life policy information may further include some other non-mandatory information, such as a policyholder's age, gender and name, as well as the life policy's status, generation date and expiration date.

Step 103: a loanable amount is analyzed according to the input life policy information and each investment proposal in the online investment database, and a plurality of loan proposals and a maximum loanable amount of a corresponding life policy are calculated.

In the technical solution of the present invention, step 103 may be implemented in a variety of ways. The technical solution of the present invention is described in detail below by taking one of the specific implementations as an example.

For example, preferably, in a specific embodiment of the present invention, step 103 includes the following.

Step 31: it is determined whether the GCV of the corresponding life policy supports all past loans and selected loans according to the input life policy information; if yes, proceeding to step 32; otherwise, ending the process.

In this step, first, it is necessary to first determine whether the GCV of the corresponding life policy supports all past loans and selected loans.

For example, preferably, in a specific embodiment of the present invention, the step of determining whether the GCV of the corresponding life policy supports all past loans and selected loans according to the input life policy information may include:

calculating a remaining loan amount (RLA) of the corresponding life policy according to the input life policy information; and

determining that the GCV of the life policy corresponding to the life policy information supports all past loans and selected loans when the RLA is greater than a preset loan threshold; otherwise, determining that the GCV of the life policy corresponding to the life policy information does not support all past loans and selected loans.

The interest-only loan, the single premium or the paid-up life policy is taken as an example, preferably, in a specific embodiment of the present invention, the RLA of the life policy may be calculated as follows:

RLA=min_{t=0 . . . max(t}_{₁}_{, . . . , t}_{ₘᵢₙ}₎GVC(t)×α−Σ_{y=1 . . . m+o}la_{y} (1)

where, RLA is the remaining loan amount of the life policy; GCV(t) is the projected guaranteed cash value of the life policy; t₁, tₘ₊ₒ are loan terms of 1^{st} to (m+o)^{th} past loans or selected loans; a is a risk factor; la_{y} is a loan amount of y^{th} past loans and selected loans; m and o are the number of the past loans and the number of the selected loans, respectively.

In the technical solution of the present invention, the value of the risk factor α may be preset. For example, preferably, a may be 80%.

Step 32: a corresponding loan proposal is generated according to the input life policy information and each investment proposal stored in the online investment database, and a maximum loanable amount aₓ of each loan proposal is calculated.

The interest-only loan, the single premium or the paid-up life policy is taken as an example, if there are n investment proposals stored in the online investment database, in this step, n corresponding loan proposals are generated, and the maximum loanable amount aₓ of each loan proposal is calculated.

It may be simply expressed as follows:

f:Iₓ(iₓ,tₓ,aiaₓ)⇒Lₓ(iₓ,tₓ,aₓ), x=1, . . . ,n; (2)

where, f indicates a function operation; Iₓ is the x^{th} investment proposal stored in the online investment database; Lₓ is the x^{th} loan proposal generated in correspondence with the Iₓ; iₓ is an interest rate of the x^{th} loan proposal; tₓ is a term of the x^{th} loan proposal; aiaₓ is an available investment amount of the x^{th} loan proposal; aₓ is a maximum loanable amount of the generated x^{th} loan proposal Lₓ.

The interest-only loan, the single premium or the paid-up life policy is taken as an example, preferably, in a specific embodiment of the present invention, the aₓ is calculated as follows:

aₓ=min{aiaₓ,[min_{t=0 . . . max(t}_{₁}_{, . . . , t}_{ₘᵢₙ}₎GVC(t)×α]−Σ_{y=1 . . . m+o}la_{y}} (3)

Step 33: it is determined whether financing is allowable according to the maximum loanable amount of each loan proposal and a preset financing threshold; if yes, proceeding to subsequent step 104; otherwise, ending the process.

In the technical solution of the present invention, a financing threshold is preset. Then, in this step, the maximum loanable amount of each loan proposal is compared with the preset financing threshold. When the maximum loanable amount of at least one loan proposal is greater than or equal to the preset financing threshold, it means that the life policy can be financed and the subsequent step 104 can be executed. When the maximum loanable amount of each loan proposal is less than the preset financing threshold, it means that the life policy cannot be refinanced in this case and the process can be ended. Additionally, at the end of the process, a first prompt message like “no financing” can be further output to prompt the user.

Preferably, in a specific embodiment of the present invention, after step 103, the method may further include:

Step 104: financing evaluation analysis is performed based on the calculated loan proposals, and evaluation statistics of each loan proposal is calculated.

In the technical solution of the present invention, the evaluation statistics can be used to quantify an interest arbitrage benefit (IAB) and compare interest spreads and risks of the loan proposals. Therefore, the evaluation statistics can also be referred to as interest spread and risk statistics, which can be used for recommendation weighting or sorting in a subsequent step.

Preferably, in a specific embodiment of the present invention, the financing evaluation analysis may be performed on each loan proposal based on a best estimate (BE) cash flow and a best estimate projected cash value PCV(t).

The interest-only loan, the single premium or the paid-up life policy is taken as an example, preferably, in a specific embodiment of the present invention, the evaluation statistics may include: a latest expected repayment period, a policy CF, a break-even interest (BEI) rate, a CF after projected premium (PP) financing, an expected IAB, an increase in an internal rate of return (IRR), and a worst-case loss (WCL).

In addition, preferably, in a specific embodiment of the present invention, the latest expected repayment period may be calculated as follows:

Rₓ=Min{β,Max T:∀_{i≤T}[(α*PCV(t)−Σ_{y=1 . . . m+o}la_{y})≥aₓ]} (5)

where, Rₓ is the latest expected repayment period of the x^{th} loan proposal; β is an expiration year of the life policy; T is a latest time point satisfying (α*PCV(t)−Σ_{y=1 . . . m+o}la_{y}≥aₓ).

In the technical solution of the present invention, the latest expected repayment period Rₓ can also be used for analyzing the CF of a policy and calculating other evaluation statistics.

For example, preferably, in a specific embodiment of the present invention, the CF of a newly-built (NB) life policy, i.e. CF_NBₓ(t), may be calculated as follows:

when t=0, CF_NBₓ(t)=−Premium (0);

when t<Rₓ, CF_NBₓ(t)=Cost of Insurance (t);

when t=Rₓ, CF_NBₓ(t)=Cost of Insurance (t)+Projected Cash Value (t); and

when t>Rₓ, CF_NBₓ(t)=0;

where, CF_NBₓ(t) is a projected CF of the x^{th} loan proposal for the NB life policy; Premium (0) is the premium of the NB life policy; Cost of Insurance (t) is a cost of insurance; Projected Cash Value (Rₓ) is the PCV of the x^{th} loan proposal.

If the life policy is an IF life policy, the cash flow of the IF life policy, CF_IFₓ(t), may be calculated as follows:

when t=0, CF_IFₓ(t)=−GCV(0);

when t<Rₓ, CF_IFₓ(t)=Cost of Insurance (t);

when t=Rₓ, CF_IFₓ(t)=Cost of Insurance (t)+Projected Cash Value (t); and

when t>Rₓ, CF_IFₓ(t)=0;

where, GCV(0) is the GCV of the IF life policy in real time.

In the technical solution of the present invention, due to the different definitions of the CFs of the NB life policy and the IF life policy, the above formula will make the IRR of the IF life policy (for example, the IF period is only one day) higher than that of the same NB life policy. Since the above evaluation statistics are only used to compare the data of one life policy under different loan proposals, in order to reduce the input of data, the above simplified method is also used in the specific embodiment of the present invention. To make the evaluation statistics of the IF life policy and the NB life policy comparable, the above formula may replace GCV(0) with [Σ_{past premium}−Σ_{past cost of insurance}−Σ_{past CF interest}], or other fine adjustments may be made.

For example, preferably, in a specific embodiment of the present invention, the BEI rate may be calculated as follows:

NB life policy: BEIₓ=IRR(CF_NBₓ); and

IF life policy: BEIₓ=IRR(CF_IFₓ);

where, BEI is the BEI rate of the x^{th} loan proposal for the life policy, namely the IRR of the CF (CF_NBₓ or CF_IFₓ) of the life policy. IRR is a discount factor (DF) that enables a present value of a cash inflow to be exactly equal to a present value of a current outflow.

When a loan interest rate is lower than the BEI rate, a premium financing interest spread will bring a benefit to the policyholder.

For example, preferably, in a specific embodiment of the present invention, the CF of the NB life policy after PP financing, CF_NB_PPₓ(t), may be calculated as follows:

when t=0, CF_NB_PPₓ(t)=−Premium(0)+aₓ;

when t<Rₓ, CF_NB_PPₓ(t)=Cost of Insurance (t)−Interestₓ (t);

when t=Rₓ, CF_NB_PPₓ(t)=Cost of Insurance (t)+Projected Cash Value (t)−Interestₓ (t)−aₓ; and

when t>Rₓ, CF_NB_PPₓ(t)=0;

where, CF_NB_PPₓ(t) is a CF of the NB life policy at a time point t after the PP financing of the x^{th} loan proposal; Interestₓ (t) is an interest payable of the x^{th} loan proposal at the time point t.

If the life policy is an IF life policy, the CF of the IF life policy, CF_IF_PPₓ(t), may be calculated as follows:

when t=0, CF_IF_PPₓ(t)=−GCV(0)+aₓ;

when t<Rₓ, CF_IF_PPₓ(t)=Cost of Insurance (t)−Interestₓ (t);

when t=Rₓ, CF_IF_PPₓ(t)=Cost of Insurance (t)+Projected Cash Value (t)−Interestₓ(t)−aₓ; and

when t>Rₓ, CF_IF_PPₓ(t)=0.

In the technical solution of the present invention, the system calculates the discount value at each time point based on the expected CF after the premium financing by using the BEI rate.

For example, preferably, in a specific embodiment of the present invention, the expected IAB may be calculated as follows:

NB life policy:

IABₓ=Σ_{t=0toR}CF_NB_PPₓ(t)×DF(t), and DF(t)=Π_{z=0to t}1/(1+BEIₓ); and

IF life policy:

IABₓ=Σ_{t=0toR}CF_IF_PPₓ(t)×DF(t), and DF(t)=Π_{z=0to t}1/(1+BEIₓ)

where, IABₓ is the expected IAB of the x^{th} loan proposal; DF(t) is the discount factor at the time point t; BEIₓ is the BEI rate of the x^{th} loan proposal.

The above formula uses BEIₓ as the discount rate, namely the discount value of the CF after PP financing, to calculate the expected IAB.

In the technical solution of the present invention, the system also calculates the increase in the IRR from the premium financing as an evaluated loan benefit.

For example, preferably, in a specific embodiment of the present invention, the increase in the IRR may be calculated as follows:

NB life policy: ΔIRR=IRR(CF_NB_PPₓ(t))−BEIₓ; and

IF life policy: ΔIRR=IRR(CF_IF_PPₓ(t))−BEIₓ.

where, ΔIRR is the increase in the IRR.

Preferably, in a specific embodiment of the present invention, the WCL of each loan proposal may be calculated, that is, an interest expense plus a loss incurred by the termination of the life policy during the term of the loan proposal and the return of principal.

Step 105: a loan recommendation and a selection list are output according to the evaluation statistics of each loan proposal.

In the technical solution of the present invention, step 105 may be implemented in a variety of ways. The technical solution of the present invention is described in detail below by taking two of the specific implementations as an example.

In a first specific implementation, a default manner is adopted.

For example, preferably, in a specific embodiment of the present invention, step 105 includes:

comparing and sorting the loan proposals according to a preset sorting parameter and the evaluation statistics of each loan proposal, and outputting a sorted list of the loan proposals.

Specifically, preferably, the preset sorting parameter may be the expected IAB or other parameter.

In a second implementation, a user inputs a normative instruction.

For example, preferably, in a specific embodiment of the present invention, step 105 includes:

Step 51: an externally input normative instruction is received.

In a specific embodiment of the present invention, the user may input a corresponding normative instruction through a user interface (UI).

For example, preferably, in a specific embodiment of the present invention, the normative instruction may include: maximizing a target parameter, such as a highest interest spread, a least cash expenditure, a lowest interest or a lowest refinancing risk.

Further, the normative instruction may include parameters such as a loan amount and/or a loan term.

Step 52: the loan proposals are compared and sorted according to the externally input normative instruction and the evaluation statistics of each loan proposal, and outputting a sorted list of the loan proposals.

Since the user can input the above normative instruction, the system can compare and sort the various loan proposals according to the normative instruction input by the user and the evaluation statistics of each loan proposal, so as to obtain and output a sorted list of the loan proposals.

After the sorted list of the loan proposals is output, the user can select a loan proposal as needed from the list of the loan proposals.

In addition, in a specific embodiment of the present invention, after step 105, the method may further include:

Step 106: a loan proposal selected by a user in the list of the loan proposals is recorded, and the online investment database is updated with an investment proposal corresponding to a newly-added selected loan of the user, and returning to step 103.

In the technical solution of the present invention, after the user selects a corresponding loan proposal from the list of the loan proposals, the loan proposal can be (but not necessarily) added to the life policy information as the newly-added selected loan of the user, and the online investment database is updated with an investment proposal corresponding to the newly-added selected loan of the user. Then, according to the updated online investment database, corresponding analysis and calculation are performed again (that is, returning to steps 103 to 105), so that a sorted list of the loan proposals can be output for the user to make a further selection. The operation is repeated until the system prompts “no financing” or other message. In this way, when the life policy of the user has a large amount and there is no single loan proposal to support with sufficient available investment amount, the present invention can maximize the available financing amount of the mortgage loan to increase the loan-to-value ratio, thereby making the peer-to-peer (P2P) mortgage lending more flexible. Therefore, all the loan proposals available to the user can be called “a basket loan”.

In addition, preferably, in a specific embodiment of the present invention, the user may also cancel one or more loan proposals in the “basket loans”, and the specific implementation will not be repeated.

In addition, preferably, in a specific embodiment of the present invention, the system may automatically add an available loan proposal to the “basket loans” of the user in a default manner.

In addition, the method of “basket loans” in the present invention can be applied to the field of insurance financing, and can also be applied to the field of non-insurance financing, which will not be repeated here.

FIG. 2 is a structural diagram of a financing analysis system based on life policy information according to an embodiment of the present invention. As shown in FIG. 2, the financing analysis system based on life policy information in the embodiment of the present invention includes the storage unit 21 and the loanable amount analysis unit 22.

The storage unit 21 is configured to store an online investment database with a plurality of investment proposals, and update the online investment database in real time or regularly.

The loanable amount analysis unit 22 is configured to receive externally input life policy information, analyze a loanable amount according to the input life policy information and each investment proposal in the online investment database, and calculate a plurality of loan proposals and a maximum loanable amount of a corresponding life policy.

In addition, preferably, in a specific embodiment of the present invention, the financing analysis system based on life policy information may further include the financing evaluation analysis unit 23.

The financing evaluation analysis unit 23 is configured to perform financing evaluation analysis based on the calculated loan proposals, calculate evaluation statistics of each loan proposal, and output a loan recommendation and a selection list according to the evaluation statistics of each loan proposal.

Preferably, in a specific embodiment of the present invention, the storage unit 21 may be further configured to record a loan proposal selected by a user from the list of the loan proposals, and update the online investment database with an investment proposal corresponding to a newly-added selected loan of the user.

In the financing analysis method and system based on life policy information of the present invention, a plurality of loan proposals for a life policy and a maximum loanable amount of the life policy can be dynamically calculated according to the current online investment database and the externally input life policy information, and then a loan recommendation and a selection list are output, so as to facilitate the policyholder to understand the maximum loanable amount of the life policy, the interest spread of financing and the personal loan proposals on the online market. In this way, even a small life policy can use its cash value as a collateral to loan, which greatly reduces the threshold of premium financing and improves the flexibility of premium financing. Therefore, the present invention can optimize loan selection and promotes policy liquidity. The present invention supports second mortgage and modification of the life policy (for example, withdrawal), and also supports the use of accrued interest of the life policy as a collateral to increase the loan amount. In this way, the present invention realizes the transparency of the loan-to-value ratio of the life policy, and solves the problem of high costs of small premium financing, a plurality of loans for one life policy or modification of a mortgage life policy.

The above merely describes preferred embodiments of the present invention, which are not intended to limit the present invention. Any modification, equivalent substitution and improvement made without departing from the spirit and principle of the present invention shall fall within the scope of protection of the present invention.

What is claimed is:

1. A financing analysis method based on life policy information, comprising the following steps:
step A: establishing an online investment database with a plurality of investment proposals, and updating the online investment database in real time or regularly;
step B: receiving the life policy information input externally; and
step C: analyzing a loanable amount according to the life policy information and each investment proposal of the plurality of investment proposals in the online investment database, and calculating a plurality of loan proposals and a maximum loanable amount of a life policy corresponding to the life policy information.

2. The financing analysis method according to claim 1, wherein the life policy information comprises:
a projected guaranteed cash value (GCV) of the life policy, information regarding whether the life policy is transferrable to a transferee, and information regarding past loans and selected loans of the life policy.

3. The financing analysis method according to claim 2, wherein the life policy information further comprises:
a best estimate projected cash value, a cost of insurance, a premium of a newly-built life policy, a cash value of a life policy in force in real time, a future premium, and a regular guaranteed cash flow of other life policy.

4. The financing analysis method according to claim 3, further comprising:
step D: performing financing evaluation analysis based on the plurality of loan proposals, and calculating evaluation statistics of each loan proposal of the plurality of loan proposals; and
step E: outputting a loan recommendation and a selection list according to the evaluation statistics of the each loan proposal.

5. The financing analysis method according to claim 4, further comprising:
step F: recording a loan proposal selected by a user from the selection list of the plurality of loan proposals, updating the online investment database with an investment proposal corresponding to a newly-added selected loan of the user, and returning to step C.

6. The financing analysis method according to claim 1, wherein step C comprises:
step C1: determining whether the GCV of the life policy corresponding to the life policy information supports all past loans and selected loans according to the life policy information;
when the GCV of the life policy supports all the past loans and the selected loans, proceeding to step C2; when the GCV of the life policy does not support all the past loans and the selected loans, ending a process;
step C2: generating a loan proposal corresponding to the life policy information and the each investment proposal stored in the online investment database, and calculating a maximum loanable amount of the each loan proposal; and
step C3: determining whether a financing is allowable according to the maximum loanable amount of the each loan proposal and a predetermined financing threshold; when the financing is allowable, proceeding to subsequent step D; when the financing is not allowable, ending the process.

7. The financing analysis method according to claim 6, wherein the step of determining whether the GCV of the life policy corresponding to the life policy information supports all the past loans and the selected loans according to the life policy information comprises:
calculating a remaining loan amount (RLA) of the life policy corresponding to the life policy information according to the life policy information; and
determining that the GCV of the life policy corresponding to the life policy information supports all the past loans and the selected loans when the RLA of the life policy is greater than a predetermined loan threshold; and
determining that the GCV of the life policy corresponding to the life policy information does not support all the past loans and the selected loans when the RLA of the life policy is equal to or less than the predetermined loan threshold.

8. The financing analysis method according to claim 7, wherein the RLA of the life policy is calculated as follows:
RLA=min_{t=0 . . . max(t}_{₁}_{, . . . , t}_{ₘᵢₙ}₎GVC(t)×α−Σ_{y=1 . . . m+o}la_{y};
wherein, RLA is the remaining loan amount of the life policy; GCV(t) is the projected guaranteed cash value of the life policy; t₁, tₘ₊ₒ are loan terms of 1^{st} to (m+o)^{th} past loans or selected loans; a is a risk factor; la_{y} is a y^{th} loan amount of all the past loans and the selected loans; m and o are a number of the past loans and a number of the selected loans, respectively.

9. The financing analysis method according to claim 8, wherein a maximum loanable amount of an x^{th} loan proposal Lₓ is calculated as follows:
aₓ=min{aiaₓ,[min_{t=0 . . . max(t}_{₁}_{, . . . , t}_{ₘᵢₙ}₎GVC(t)×α]−Σ_{y=1 . . . m+o}la_{y}};
wherein, aₓ is the maximum loanable amount of the x^{th} loan proposal Lₓ; aiaₓ is an available investment amount of the x^{th} loan proposal.

10. The financing analysis method according to claim 4, wherein the evaluation statistics comprises:
a latest expected repayment period, a policy cash flow, a break-even interest rate, a cash flow after projected premium financing, an expected interest arbitrage benefit, an increase in an internal rate of return, and a worst-case loss.

11. The financing analysis method according to claim 10, wherein step E comprises:
comparing and sorting the plurality of loan proposals according to a predetermined sorting parameter and the evaluation statistics of the each loan proposal, and outputting a sorted list of the plurality of loan proposals.

12. The financing analysis method according to claim 10, wherein step E comprises:
receiving an externally input normative instruction; and
comparing and sorting the plurality of loan proposals according to the externally input normative instruction and the evaluation statistics of the each loan proposal, and outputting a sorted list of the plurality of loan proposals.

13. The financing analysis method according to claim 12, wherein the externally input normative instruction comprises:
maximizing parameters such as a target parameter, a loan amount and/or a loan term.

14. A financing analysis system based on life policy information, comprising a storage unit and a loanable amount analysis unit; wherein
the storage unit is configured to store an online investment database with a plurality of investment proposals, and update the online investment database in real time or regularly; and
the loanable amount analysis unit is configured to receive the life policy information input externally, analyze a loanable amount according to the life policy information and each investment proposal of the plurality of investment proposals in the online investment database, and calculate a plurality of loan proposals and a maximum loanable amount of a life policy corresponding to the life policy information.

15. The financing analysis system according to claim 14, further comprising a financing evaluation analysis unit; wherein
the financing evaluation analysis unit is configured to perform financing evaluation analysis based on the plurality of loan proposals, calculate evaluation statistics of each loan proposal of the plurality of loan proposals, and output a loan recommendation and a selection list according to the evaluation statistics of the each loan proposal.

16. The financing analysis system according to claim 14, wherein
the storage unit is further configured to record a loan proposal selected by a user from a list of the plurality of loan proposals, and update the online investment database with an investment proposal corresponding to a newly-added selected loan of the user.

17. The financing analysis method according to claim 2, wherein step C comprises:
step C1: determining whether the GCV of the life policy corresponding to the life policy information supports all past loans and selected loans according to the life policy information; when the GCV of the life policy supports all the past loans and the selected loans, proceeding to step C2; when the GCV of the life policy does not support all the past loans and the selected loans, ending a process;
step C2: generating a loan proposal corresponding to the life policy information and the each investment proposal stored in the online investment database, and calculating a maximum loanable amount of the each loan proposal; and
step C3: determining whether a financing is allowable according to the maximum loanable amount of the each loan proposal and a predetermined financing threshold; when the financing is allowable, proceeding to subsequent step D; when the financing is not allowable, ending the process.

18. The financing analysis method according to claim 3, wherein step C comprises:
step C1: determining whether the GCV of the life policy corresponding to the life policy information supports all past loans and selected loans according to the life policy information; when the GCV of the life policy supports all the past loans and the selected loans, proceeding to step C2; when the GCV of the life policy does not support all the past loans and the selected loans, ending a process;
step C2: generating a loan proposal corresponding to the life policy information and the each investment proposal stored in the online investment database, and calculating a maximum loanable amount of the each loan proposal; and
step C3: determining whether a financing is allowable according to the maximum loanable amount of the each loan proposal and a predetermined financing threshold; when the financing is allowable, proceeding to subsequent step D; when the financing is not allowable, ending the process.

19. The financing analysis method according to claim 4, wherein step C comprises:
step C1: determining whether the GCV of the life policy corresponding to the life policy information supports all past loans and selected loans according to the life policy information; when the GCV of the life policy supports all the past loans and the selected loans, proceeding to step C2; when the GCV of the life policy does not support all the past loans and the selected loans, ending a process;
step C2: generating a loan proposal corresponding to the life policy information and the each investment proposal stored in the online investment database, and calculating a maximum loanable amount of the each loan proposal; and
step C3: determining whether a financing is allowable according to the maximum loanable amount of the each loan proposal and a predetermined financing threshold; when the financing is allowable, proceeding to subsequent step D; when the financing is not allowable, ending the process.

20. The financing analysis method according to claim 5, wherein step C comprises:
step C1: determining whether the GCV of the life policy corresponding to the life policy information supports all past loans and selected loans according to the life policy information; when the GCV of the life policy supports all the past loans and the selected loans, proceeding to step C2; when the GCV of the life policy does not support all the past loans and the selected loans, ending a process;
step C2: generating a loan proposal corresponding to the life policy information and the each investment proposal stored in the online investment database, and calculating a maximum loanable amount of the each loan proposal; and
step C3: determining whether a financing is allowable according to the maximum loanable amount of the each loan proposal and a predetermined financing threshold; when the financing is allowable, proceeding to subsequent step D; when the financing is not allowable, ending the process.
